(19) United States
(12) Patent Application Publication
(10) Pub. No.: US 2024/0421509 A1
(43) Pub. Date: Dec. 19, 2024

(54) Contact carrier apparatus, connection device, actuator, plug-in connector insert and installation method, and cable connection system

(71) Applicant: HARTING Electric Stiftung & Co. KG, Espelkamp (DE)

(72) Inventors: Norbert KROPIEWNICKI, Bielefeld (DE); Sergej ZIER, Löhne (DE)

(73) Assignee: HARTING Electric Stiftung & Co. KG, Espelkamp (DE)

(21) Appl. No.: 18/701,278

(22) PCT Filed: Oct. 25, 2022
(86) PCT No.: PCT/DE2022/100790

§ 371 Date: Apr. 15, 2024

(30) Foreign Application Priority Data
Nov. 8, 2021 (DE) 10 2021 129 010.4

(51) Int. Cl. H01R 4/48; H01R 11/05; H01R 13/506; H01R 13/516; H01R 13/64; H01R 43/20

(52) U.S. Cl. CPC H01R 4/4821; H01R 4/4833; H01R 4/48365; H01R 11/05; H01R 13/506; H01R 13/516; H01R 43/20; H01R 13/64

(57) ABSTRACT

In order to design a cable connection system so as to be operable particularly reliably and to be simultaneously compact, the actuator (1′) is provided at the ends of its actuation arms (122) with an actuation web (123), in the form of a protrusion (13), for reducing friction forces. In order to save on construction space for the collar of an electric cable and for regions of a clamping spring, the actuator (1′) has a receiving opening (120) above the actuation web (123). For the resultantly necessary stabilization, it has stiffening ribs (127) which are integrally formed on the outside of the actuation arms (122). As a result, the actuator (1′) can advantageously be manufactured from plastic and nevertheless have sufficient stability. In addition, the stiffening ribs (127) can be used as an installation aid.

### CROSS-REFERENCE TO RELATED APPLICATION

This application is a national stage application, filed under 35 U.S.C. § 371, of International Patent Application PCT/DE2022/100790, filed on Oct. 25, 2022, which claims the benefit of German Patent Application DE 10 2021 129 010.4, filed on Nov. 8, 2021.

### TECHNICAL FIELD

The disclosure relates to a contact carrier apparatus, to a connection device comprising the contact carrier apparatus and a contact unit inserted therein, to an actuator for the connection device, and to a plug-in connector insert comprising the connection device and the a plug-in contact. The disclosure further relates to an installation method for a plug-in connector insert and to a cable connection system comprising a plug-in connector insert and an electrical cable.

### BACKGROUND

Contact carrier apparatuses are required for receiving contact units, in particular comprising a plug-in contact, and also for connecting an electrical conductor to the contact unit, that is to say electrically conductively connecting said electrical conductor to and mechanically holding/fixing said electrical conductor on the contact unit, but also for enabling said electrical conductor to be released from said contact unit again without great effort when required. Such an electrical conductor may in particular be a wire of an electrical cable and/or the crimped region of a wire end ferrule that has been crimped thereon.

For example, said plug-in connector insert may be suitable for being installed (that is to say “inserted”) directly into a plug-in connector housing, for example a hood, bulkhead housing or surface mounted housing. The plug-in connector insert may however in particular also be a so-called “plug-in connector module”, which is arranged (that is to say “inserted”), together with other plug-in connector modules as part of a modular plug-in connector system, in a modular plug-in connector frame, wherein the modular plug-in connector frame can be fastened for example in a plug-in connector housing or at a wall opening. Here, the other plug-in connector modules of the modular plug-in connector system may be individually combined in accordance with the desired function in the particular usage situation, for example for optical and/or electrical analog and/or digital signal transmission, electrical energy transmission, transfer of gases and pressure (pneumatics), or for the purposes of measuring, evaluating and processing data in relation to current, voltage or temperature.

So-called “push-in technology” for the connection of electrical cables to electrical apparatuses is known from the prior art. In the case of one particular type of these electrical cable connection systems, it is known in particular for the electrical cable to be inserted manually into a cage-like busbar. A substantially V-shaped clamping spring is then supported by way of its first limb, namely its holding limb, against a first cage wall of the busbar, and, by way of its second limb, namely its clamping limb, presses a wire of the inserted electrical cable against a second cage wall that is situated opposite the first cage wall, in order to thus electrically contact the wire of the cable, which has been stripped at the end, with the busbar. Thus, the particularly user-friendly manual activity in this connection operation is restricted to the insertion of the electrical cable.

In this context, numerous documents, for example the document WO 2018/178164 A1, furthermore disclose the use of an actuator which serves to enable the electrical cable to be released from the busbar again when required. By virtue of the actuator being transferred or pushed down into its release position, the clamping spring is elastically deformed and releases the electrical cable again. The aforementioned document discloses the provision of a receiving pocket in the actuator, in order that the clamping spring is received with its spring bend to a greater depth in said receiving pocket of the actuator during the actuating operation. In particular, said document discloses a particularly compact design, which arises from the fact that the actuator has a cable-receiving depression which is oriented toward the conductor-receiving space and which extends in an insertion direction and which reduces the spacing between the actuation element and the cable. Two sliding rails are thus formed to both sides of the receiving depression, which sliding rails bear against sliding edges, extending in the insertion direction, of the busbar and slide along said sliding edges when the actuator is actuated.

The applicant's German patent application publication DE102021117060 deals with the fundamental problem of designing and improving such systems. Aside from the desire for as compact a design as possible, in particular of the contact carrier, it is sought that the actuator, after being actuated, is moved back into its initial position automatically, and as reliably as possible, using the simplest possible means. A further advantage of the design disclosed in said document consists in that an installation process is facilitated; this is achieved by virtue of the actuator being preinstalled on the holding plate.

However, numerous tests and simulations in the development process have shown the lack of mechanical stability of the actuator to be a problem. In the aforementioned design, the actuator has, at a cable connection side of its actuation web, a passage opening which, despite advantageously providing a maximum saving of space in the contact chamber, disadvantageously also decreases the stability of the actuator. Furthermore, the actuator has latching recesses which serve for the aforementioned preinstallation on the holding plate and which likewise decrease the stability of the actuator, such that, under adverse circumstances, an actuator of said type, when actuated, can break under the force exerted by the clamping spring.

In the priority application relating to the present application, the German Patent and Trade Mark Office conducted a search in respect of the following documents: DE 10 2021 108 600 B3, DE 10 2020 101 653 A1, WO 2016/083966 A1 and WO 2018/178164 A1.

### SUMMARY

The present application provides an improved design for a contact carrier apparatus which is as compact and at the same time as operationally reliable as possible. A further aspect provides an adequately stable design for an associated actuator, which in particular makes it possible for the actuator to be produced from plastics material in a particularly economical injection molding process. In particular, the design of the actuator should furthermore allow the simplest possible installation of the contact carrier apparatus.

A contact carrier apparatus has a contact carrier which has a connection region at a cable connection side and has at least one contact chamber, which is open at a cable connection side, for receiving a contact unit. The contact carrier apparatus furthermore has a holding plate which is connectable and fixable at a cable connection side to the contact carrier and which has an actuation opening for each contact chamber and has a connection opening, which is adjacent to the actuation opening and/or connected to the actuation opening, for the insertion of an electrical conductor at a cable connection side into the contact chamber in an insertion direction.

The contact carrier apparatus has, at each actuation opening, in each case one actuator, which is arranged at least partially in the corresponding contact chamber and which is held therein so as to be actuatable in an actuation direction, for releasing the electrical conductor from the contact unit.

The actuator has a holding portion having an engagement surface, with which, for example, a tool such as a screwdriver can be engaged, and also has an actuation portion having two lateral actuation arms extending in the actuation direction, which actuation arms are in particular of substantially planar design. The actuator furthermore has an actuation web, which connects the actuation arms at the ends, for actuating the contact unit. In particular, the actuator may be capable, by way of its actuating web, of actuating a clamping limb of a V-shaped clamping spring of the contact unit. Owing to the actuation web, the actuator is of open design between its two actuation arms in the region between its actuation web and its holding portion, that is to say said actuator has a passage opening extending, at least in certain portions, perpendicularly with respect to the actuation direction, which has the advantage that the free space in the contact chamber is maximized. For example, said free space can be utilized to accommodate electrical conductors with a particularly large conductor cross section for contacting purposes, and/or the free space can be utilized, for example during the actuation operation, to receive particularly large parts of the V-shaped clamping spring in the contact chamber.

In each case one stiffening rib is formed at the outside, i.e. so as to be mutually averted, on each of the two fastening arms of the actuator.

A major advantage of said stiffening rib consists in the stabilization of the actuator. As will be discussed in more detail below, said stiffening rib can also constitute an important installation aid.

The actuation direction of the actuator and the insertion direction of the electrical conductor may preferably extend parallel to one another. This means that the electrical conductor is inserted into the contact carrier apparatus in the same direction as that in which the actuator is movable, that is to say actuatable, for the purposes of actuation.

The stiffening rib of the actuator may preferably extend in the actuation direction of the actuator so as not to impede the actuator during the actuation thereof.

The electrical conductor may in particular be the wire, for example a stranded wire, of an electrical cable. In particular, the electrical cable may, at its stripped contact portion at the end, be provided with a wire end ferrule, such that the electrical conductor may in this case be constituted by the wire together with a crimped region of the wire end ferrule.

The actuation web may preferably form a projection on the actuator. This is particularly advantageous because, owing to the small contact area between the actuator and the busbar, friction is reduced, specifically both when the actuator is actuated and when said actuator automatically returns into its initial position owing to the force exerted by the clamping spring. The actuation web may furthermore have a rounded form. Friction can thus advantageously be yet further reduced.

A particularly major advantage of the aforementioned design is that the actuator, despite its space-saving design, can consist of plastics material. The necessary electrically insulating properties can thus be ensured. At the same time, sophisticated shaping is made possible. Furthermore, such a design consisting of plastics material can also be implemented cost-effectively, or in other words, is acceptable from a cost aspect even in the case of precise specifications. Owing to the aforementioned design, the actuator can advantageously be produced and used with adequately high stability, even under otherwise adverse circumstances.

An additional advantage of the stiffening ribs, aside from the desired higher stability of the actuator, is that they significantly facilitate installation.

In an alternative refinement which is less preferable in this case but which is likewise disclosed here, the actuator could have latching recesses. By means of such latching recesses, a multiplicity of such actuators can initially be held in a preinstalled state in the holding plate. During the final installation process, that is to say when holding plate and contact carrier are plugged together and fixed to one another, all of the actuators of this arrangement would then automatically be inserted into the associated contact chambers of the contact carrier, and would automatically be situated in a suitable, defined relative position with respect to the holding plate. For this reason, this variant would be of great interest from a manufacturing aspect; however, as already mentioned, it would unfortunately have the aforementioned disadvantage of possible insufficient stability of the actuator, depending on other parameters such as the material of the actuator.

By contrast, in a refinement which is expressly preferred here, the actuator that has stiffening ribs rather than latching recesses can be held by way of its stabilizing stiffening ribs in a suitable preinstallation position in the contact carrier whilst the holding plate is latched onto the contact carrier, which thus constitutes a major additional advantage of the stiffening ribs aside from the stabilization. To this end, for the purposes of facilitating installation, the contact carrier has, within each of its contact chambers on two mutually opposite sides of the particular contact chamber, in each case one inwardly directed installation strip extending in an insertion direction. These two installation strips in each contact chamber interact with the stiffening ribs of the actuator in its preinstallation position, such that, as the holding plate is installed on the contact carrier, the actuator cannot tilt in the direction of its actuation web. Thus, as already mentioned, a further advantage of this preferred design consists in that it facilitates installation, whilst at the same time stabilizing the actuator.

In other words, in each case one inwardly directed installation strip extending in an actuation direction may be arranged in each contact chamber on two mutually opposite sides. These two installation strips in each contact chamber may be situated symmetrically opposite one another. In this regard, it is furthermore particularly advantageous if the stiffening ribs extend in the actuation direction, in particular because they thus do not impede the actuation of the actuator. If the actuator has been inserted into the contact chamber for preinstallation purposes, the interaction of its stiffening ribs with said installation strips thus prevents said actuator from “tilting” to too great a degree, that is to say from becoming too steeply inclined in the direction of its actuation web. The holding plate can thus be latched without great effort onto the contact carrier with the actuators that have already been inserted, whereby each actuator is definitively guided by the holding plate. During the course of the actuation of the actuator, the stiffening ribs are specifically not in mechanical contact with the installation strips, which therefore, as discussed above, serve to facilitate installation in this way but do not guide the actuator during the actuation thereof. Instead, during the actuation thereof, the actuator can preferably be guided by parts of the holding plate, of the contact carrier and/or of the busbar, in particular by sliding edges of the busbar.

In a further aspect, an actuator of the aforementioned type is disclosed. The actuator consists of plastics material, in particular of glass-fiber-reinforced polyamide, and is preferably produced by injection molding. Injection molding is advantageously particularly highly suitable for inexpensive mass production with sophisticated shaping.

The actuator has the holding portion having said engagement surface, with which, for example, a tool such as a screwdriver can be engaged, and also has the actuation portion having the two lateral actuation arms extending in the actuation direction, which actuation arms are in particular of substantially planar design. The actuator furthermore has the actuation web which connects the actuation arms at the ends and which serves for actuating the contact unit, in particular the clamping limb of the V-shaped clamping spring. In each case one of said stiffening ribs is formed at the outside on each of the two fastening arms of the actuator. The stiffening ribs are thus arranged, so as to be mutually averted, at the outside on the actuation arms.

In one advantageous refinement, the stiffening ribs of the actuator may have a length in the actuation direction which corresponds to at least ½ (“half”), in particular at least ⅔ (“two thirds”), preferably at least ¾ (“three quarters”), and particularly preferably at least ⅘ (“four fifths”), of the length of the actuator in the actuation direction.

The stiffening ribs may extend over approximately the entire actuation portion of the actuator and into the holding portion of the actuator.

The thickness of the stiffening ribs may advantageously at least correspond to, or be even greater than, the thickness of the actuation arms. The thickness is self-evidently measured here in each case at right angles to the surface of the actuation arms.

In a further advantageous refinement, the stiffening rib may have a width perpendicular to the actuation direction but parallel to the surface of the particular actuation arm on which it is formed, said width corresponding to at least ¼ (“one quarter”), in particular at least ⅓ (“one third”), preferably at least ½ (“half”), for example at least ⅔ (“two thirds”), for example at least ¾ (“three quarters”) and particularly preferably at least ⅘ (“four fifths”) of the width of the holding portion of the actuator at its narrow-side surfaces. Ideally, the stiffening ribs may be of exactly the same width as the narrow side of the holding portion of the actuator.

In one preferred refinement, the stiffening rib may thus be at least half as wide as a narrow-side surface, on which the stiffening rib is at least partially formed, of the preferably substantially cuboidal holding portion of the actuator.

In one specific refinement, the stiffening rib may be of exactly the same width as a narrow-side surface, on which the stiffening rib is at least partially formed, of the preferably substantially cuboidal holding portion of the actuator.

The particular advantage of a stiffening rib which is as wide as possible, and which may ideally be of exactly the same width as the narrow side of the holding portion, consists in the greater stabilizing action of relatively wide stiffening ribs in relation to relatively narrow stiffening ribs. Based on the type of construction and depending on the structural size and corresponding design, it may however be necessary to use the aforementioned relatively narrow stiffening ribs in order to create space for other structural details of the holding plate and/or of the contact carrier in order to implement the desired compactness of the design.

Ideally, this actuator optimizes the compactness of the contact carrier apparatus and the operational reliability of an electrical connection device, which will be described below. For the reasons stated above, it is particularly advantageous if the actuator consists of plastics material, in particular of glass-fiber-reinforced polyamide. This production from plastics material, for example by injection molding, is made possible in particular by the presence of said stiffening ribs.

The electrical connection device already mentioned above has the contact carrier device of the aforementioned type and has a cage-like busbar, the V-shaped clamping spring, and an electrical conductor which is to be inserted, or which has been inserted, into the busbar in an insertion direction. The electrical conductor may in particular be the wire of an electrical cable, optionally reinforced by the aforementioned wire end ferrule. It is then possible in particular for the electrical cable to be inserted into the busbar in an insertion direction. The cable thus has said electrically conductive wire, has a transmission portion and, at its end that is to be inserted into the busbar, has a contact portion. In its transmission portion, the electrical cable has an electrically insulating sheath that radially surrounds the wire. The contact portion of the cable serves for making electrical contact with the busbar and therefore has no electrically insulating sheath, such that the wire of the cable is not sheathed in the contact portion. Adjacent to the contact portion, the cable has a collar on its transmission portion. The collar consists of an electrically insulating material and may be formed by an end portion of the sheath. The cable may in particular have, at the end, a wire end ferrule which is fitted and crimped onto the cable end that is to be inserted. Said collar may then belong to the wire end ferrule. In particular, the collar is then a so-called “protective collar” of the wire end ferrule.

The cage-like busbar has a cage comprising two, in particular mutually parallel and opposite, cage walls, namely a first and a second cage wall, which are connected to one another by two further walls of the cage, namely two side walls. The two side walls each have, at a cable connection side, a stepped portion that forms a sliding edge extending in the insertion direction and a counterpart stop edge extending preferably at right angles to said sliding edge. Here, the term “cable connection side” refers to the side of the busbar from the direction of which the cable is inserted into the busbar. The busbar is entirely or at least partially open at a cable connection side, that is to say at its cable connection side, so as to allow the cable/the electrical to be inserted.

The V-shaped clamping spring has a holding limb which is fastened to or at least held against the first cage wall. Said clamping spring has, adjoining its holding limb, a spring bend, and, adjoining this, a clamping limb which is elastically pivotable so as to impart a spring force as an opposing force. The clamping limb serves, in the non-actuated state of the clamping spring, to press the contact portion of the inserted electrical cable against the second cage wall of the busbar in order to electrically connect the wire of the electrical cable to the busbar and at the same time secure the cable, by clamping it, so as to prevent said cable from being inadvertently pulled out counter to the insertion direction.

The actuator serves for transferring the clamping spring from its aforementioned non-actuated state into an actuated state, wherein the clamping limb, when in the actuated state, has been pivoted in the insertion direction relative to the non-actuated state, such that the clamping spring imparts an opposing force, in order to release the cable again so as to enable it to be pulled out at a cable connection side when required.

For this purpose, the actuator has two actuation arms and has an actuation web, which connects the actuation arms at the ends, for actuating the clamping limb of the clamping spring. The actuation arms may be of substantially planar design, and may preferably extend parallel to, and particularly preferably lie in a plane with, the side walls of the busbar. For the purposes of actuation, the actuator may be moved manually in the insertion direction. Here, the actuation web of the actuator consequently also moves in the insertion direction, and at the same time along the clamping limb, which thus pivots elastically in the insertion direction. The spring force, which increases during this process, as an opposing force of the clamping limb simultaneously acts on the actuator via the actuation web at least with a vector component counter to the insertion direction.

The actuation web of the actuator preferably forms a projection and is in mechanical contact with the sliding edges of the busbar. Said actuation web preferably extends perpendicularly with respect to the sliding edges, so as to be capable of sliding along the sliding edges, in particular transversely with respect to the direction of its own profile, in order to guide the actuator, in particular during the translational movement thereof in and counter to the actuation direction.

The use of such an actuation web is thus advantageous because the friction between the actuator and the sliding rails is this significantly reduced. This applies in particular to the static friction that arises between the actuator in its actuated state and the sliding edges. This is advantageous in particular because the expenditure of force that is required to return the actuator, after the actuation thereof, from its actuated position into its non-actuated position is minimized.

Even a relatively low spring force/spring constant can advantageously thus suffice to transfer the actuator from its actuated state into its non-actuated state. Through the use of the actuation web, the common region of mechanical contact between the actuator and the busbar is extremely small, whereby only very low friction, and in particular only very low static friction in the actuated state, arises between said components. The risk that the actuator becomes stuck in its actuated position and can be moved back into its initial position only by manual intervention is avoided or—in particular depending on the further circumstances such as the dimensioning of the further system components—at least very greatly reduced by means of this design.

This effect can be advantageously enhanced by virtue of the actuation web having a rounded form facing the sliding edges. For example, at its longitudinal edge that faces toward the sliding edges, the actuation web may be rounded either over its entire length or at least in the region by which it makes mechanical contact with the sliding edges.

In order to maintain its basic orientation, the actuator may be accommodated together with the busbar in the contact carrier, in particular in a connection region, at a cable connection side, of the contact carrier. In particular, the actuator may be received and held in recessed fashion, and with a certain degree of play (mechanical tolerance), in the contact carrier or at least in a system formed from the contact carrier and the holding plate, wherein no significant frictional force arises between the actuator and the contact carrier and, if applicable, the holding plate. It must be ensured here that the actuator is pushed only with its actuation web against the sliding rails of the busbar by the clamping spring, such that the friction during actuation and return of the actuator arises substantially, that is to say in a good approximation, at this location. The installed actuator preferably has sufficient play relative to the contact carrier/the holding plate to prevent or at least minimize friction forces.

The actuator may be actuatable through an actuation opening of the contact carrier, for example using a tool, in particular a screwdriver or a special tool. Furthermore, the contact carrier may have, at a cable connection side, a connection opening through which the cable can be inserted into the busbar.

In order to form a constituent part of a plug-in connector, namely a constituent part of a plug-in connector insert of the plug-in connector, the contact carrier may have a plug-in region with a plug-in side, which is in particular situated opposite the cable connection side of the contact carrier. The plug-in connector insert may furthermore have a plug-in contact which is electrically conductively connected to the busbar and which is in particular mechanically fastened thereto, for example at a connecting portion of the busbar. The plug-in contact itself may be arranged in a contact chamber, which is open at a plug-in side, of the plug-in region of the contact carrier, for example in order to be plugged together with a further plug-in contact of a further plug-in connector and thus to produce an electrical connection between the wire of the cable and the further plug-in contact.

It is particularly advantageous if the actuator in the described design can, after the actuation thereof, be automatically and reliably returned into its non-actuated initial position by the spring force of the contact spring alone.

A further advantage consists in that electrical cables with relatively large cable cross sections can be used, wherein the term “cable cross section” refers to the cross-sectional area of the wire of the cable. The term “relatively” relates to the dimensions of the other components, in particular of the cage-like busbar, more specifically to the dimensions of the cage, that is to say of the cage walls and side walls. In other words, the cage-like busbar and in particular its cage can be particularly compact in relation to the cable cross sections that can be used. The contact carrier apparatus can thus self-evidently also be particularly compact. Accordingly, the contact carrier/the contact carrier apparatus and the plug-in connector insert can also be extremely compact in relation to the cable cross section and in relation to the number of cables that are to be connected.

The disclosed design also has a further advantage. Owing to the reduction of the aforementioned friction, in particular the aforementioned static friction, design freedom is created at other locations for the parameters of the components, for example thickness, shape and material of the contact spring. By virtue of the fact that the actuator has an opening above its actuation web, a relatively large amount of space in relation to the compactness of the overall arrangement is provided in the contact chamber for the movement and/or deformation of the clamping spring, which advantageously offers a particularly great amount of design freedom for the configuration of the clamping spring. Owing to the stiffening ribs, this is possible even whilst achieving adequate stability of the actuator, along with acceptable production costs owing to the fact that it is produced from plastics material by injection molding.

In one advantageous refinement, the actuation arms may have, at the ends, stop edges by which the actuator, in the actuated state, abuts against the counterpart stop edges of the side walls. This is particularly advantageous because overstretching of the clamping spring is thus prevented in an effective and straightforward manner.

Owing to this stop formed from the stop edges of the actuator and the counterpart stop edges of the side walls, the actuator is furthermore situated in an exactly defined position when in its actuated position. Whilst only the sliding friction has to be overcome between the actuator and the sliding edges of the side wall during the course of the actuation, static friction arises between the actuator and the sliding edges in the actuated state, and this is naturally significantly greater than the aforementioned sliding friction.

For this reason, the use of said actuation web is particularly advantageous for such an arrangement. Specifically, since the actuator has only a very small area of contact with the side walls owing to its actuation web extending transversely with respect to the sliding edges, static friction is also reduced with such an arrangement. Thus, a spring force that is sufficient to transfer the actuator, after the actuation thereof, back into its initial position is even lower than would be the case for example if the actuator instead had sliding rails extending in the insertion direction, in the case of which the large area of contact would naturally give rise to significantly greater static friction between the actuator and the side walls. The use of the actuation web advantageously firstly provides greater freedom for the further design, in particular for the dimensioning of other components such as the spring, and/or secondly provides increased reliability of the automatic return of the actuator, after the actuation thereof, into its non-actuated position.

It is furthermore advantageous if the clamping limb of the clamping spring has a protuberance which is in mechanical contact with the actuation web of the actuator in the actuated state, that is to say in particular whilst the actuator abuts, by way of the stop edges of its actuation arms, against the counterpart stop edges of the side parts. The restoring spring force exerted on the actuator in the moment in which static friction acts can be increased by means of this protuberance because, in this way, in accordance with the lever principle, a relatively large pivoting movement of the clamping limb causes a relatively small movement of the actuator. The force exerted on the actuator by the spring counter to the actuation direction is thus ultimately increased at the exact moment at which static friction must be overcome. At the same time, owing to the protuberance, the vector component which extends perpendicularly with respect to the insertion direction and which pushes the actuation web of the actuator against the sliding rail decreases, which furthermore reduces the friction, in particular the static friction, in the aforementioned moment in which the actuator is stationary. In return, the vector component counter to the actuation direction, which thus returns the actuator into its initial position, increases.

However, the formation of the protuberance may be limited in favor of other properties of the contact spring, for example the shape of an adjoining contact region of the contact spring. The reduction of the friction, in particular of the aforementioned static friction, achieved through the use of the, in particular rounded, actuation web thus advantageously creates design freedom.

For the compactness of this design, it is furthermore particularly advantageous if the actuator is of open design between its preferably planar actuation arms in the region between its actuation web and the holding portion. In other words, said actuator has a passage opening extending, at least in certain portions, perpendicularly with respect to the actuation direction. This is particularly advantageous because it allows cables with cable cross sections that are relatively large in relation to the busbar to be inserted into the busbar and electrically contacted with the busbar in the aforementioned manner. Here, it is clear to a person skilled in the art that the term “cable cross section” relates to the cross-sectional area of the wire of the electrical cable, because it is this that is of significance for the electrical characteristics.

The actuation web on the actuator preferably forms a projection, or at least a part of a projection, in the direction of the sliding edges. This is advantageous for preventing other regions of the actuator, in particular its side parts, from making contact with the busbar, in particular with the sliding edges thereof, in order to thus ensure the aforementioned low friction resistance between the actuator and the busbar. As will be discussed in more detail below, this additionally contributes to the compact design, because space is thus created for the collar of the cable.

Specifically, the collar of the cable ends at the cable connection side of the actuation web, in particular both in the actuated state and in the non-actuated state of the actuator, and thus self-evidently also during the course of the actuation. This is particularly advantageous because, in this way, even with a compact design and the aforementioned reduction of the static friction through the use of the aforementioned actuation web, it is nevertheless also possible to use electrical cables with particularly large cable cross sections.

In particular, the collar of the cable can furthermore protrude at least in certain regions between the two actuation arms, whereby the design can be made even more compact in relation to the cable cross section.

As already mentioned, the collar of the cable is normally the protective collar of a wire end ferrule. If a cable without a wire end ferrule is used, the collar of the cable may also consist in the sheath of the cable.

In practice, the contact portion of the cable is normally a so-called “stripped” region of the cable.

It is known to a person skilled in the art to firstly cut a cable having an insulating sheath (“insulation”) to the desired length and to then remove the sheath in the end portion, which is referred to in technical parlance as “stripping”, whereby the aforementioned contact portion is formed at that end of the cable which is to be inserted.

It is also known to a person skilled in the art to optionally fit, in particular crimp, a wire end ferrule onto the cable at its stripped end, wherein the wire end ferrule is in particular provided with a protective collar.

If the cable has a wire end ferrule, the protective collar thereof may form the collar of the aforementioned arrangement. In the case of cables which do not have a wire end ferrule, the collar may be formed by the end portion of the insulating sheath.

The clamping spring preferably has one or more holding openings in its holding limb. The first cage wall may have matching embossed portions which engage into the holding portions and which thus prevent the clamping spring from moving counter to the insertion direction. For fastening purposes perpendicularly with respect thereto, it is generally sufficient for the clamping spring to be supported by way of its clamping limb against the second cage wall and to thus press its holding limb against the first cage wall.

In principle, the busbar may be formed as a single piece from a single metallic material, for example by die casting or milling from a solid piece.

Alternatively, the busbar may be formed from several different, in particular metallic, materials such as zinc alloys and/or copper alloys and/or aluminum alloys and/or one or more identical or different metal sheets, for example high-grade steel sheet.

A plug-in connector insert has the above-described electrical connection device and has a plug-in contact which is electrically connected to the busbar and mechanically fastened, for example riveted, to the busbar. The contact carrier then has, at a plug-in side of the connection region, a plug-in region in which, for each contact chamber, there is arranged a plug-in opening which is connected to the particular contact chamber and in which the particular plug-in contact is received.

The connection region of the contact carrier may be substantially cuboidal and thus have two mutually opposite narrow-side walls and, at right angles with respect thereto, two mutually opposite wide-side walls, wherein the contact carrier has, on the two narrow-side surfaces, in each case one latching lug for fixing in a modular plug-in connector frame. The plug-in connector insert that has such a contact carrier may thus preferably be a plug-in connector module that is provided for being received and held together with other plug-in connector modules in a modular plug-in connector frame. The two latching lugs may differ from one another in terms of their shape in order to ensure correct polarization of the plug-in connector module in the modular plug-in connector frame, which has recesses, in particular windows, matching each of the latching lugs.

A plug-in connector insert may be installed as follows:
A. At least one contact unit is inserted from the direction of a cable connection side into at least one contact chamber of the contact carrier.
B. At least one actuator is inserted from the direction of a cable connection side into the at least one contact chamber of the contact carrier, and is held in a preinstallation position by means of the contact carrier, in particular by means of the aforementioned installation strips.
C. The holding plate is thereupon joined to the contact carrier.
D. By virtue of the holding plate being definitively latched to the contact carrier, guidance of the at least one actuator on one or more contours of the holding plate is established.

Method step B in particular is advantageous because the actuator cannot tilt in the contact chamber during the installation process owing to the installation strips, and is thus situated in a correct relative position with respect to the holding plate in order to be correctly positioned on the holding plate.

Some of the aforementioned features/feature combinations can be summarized, in greatly simplified form, as follows:

In order to make the cable connection system particularly reliable in terms of operation and at the same time compact, the actuator is equipped, at the ends of its actuation arms, that is to say at the end of its actuation portion, with the actuation web, which is designed in particular as a projection. By way of the actuation web, the actuator is guided on sliding edges of the busbar and actuates the clamping limb of the V-shaped clamping spring. In this way, the friction between the actuator and the busbar, in particular the static friction in the actuated state, is reduced, and space for the collar of the cable is created at the cable connection side of the actuation web. Specifically, the collar of the cable is arranged at a cable connection side of the actuation web and may furthermore in particular protrude between the two actuation arms of the actuator, particularly preferably into a receiving opening that extends into the projection. Since the actuator is of open design between its actuation arms between its actuation web and its holding portion, that is to say has a passage opening extending, at least in certain regions, at right angles with respect to the actuation direction, the structural space in the contact chamber for receiving at least a part of the clamping spring and of the electrical conductor is further optimized. The stability of the actuator is thus naturally reduced, which is disadvantageous. This is compensated for by the aforementioned stiffening ribs that are formed at the outside on the actuation arms, such that the actuator can advantageously be manufactured from plastics material and exhibit adequate stability.

Furthermore, the aforementioned stiffening ribs can advantageously be used as an installation aid. Specifically, by means of installation strips arranged in the contact chambers of the contact carrier, in conjunction with the aforementioned stiffening ribs, preinstallation of the actuator in the contact carrier is made possible, because the actuator can no longer tilt owing to the interaction of its stiffening ribs with the installation strips. The actuators arranged (“preinstalled”) in the contact carrier are thus situated in a correct relative position with respect to the holding plate when the holding plate is latched onto the contact carrier.

The stiffening ribs can thus perform a dual function, specifically firstly the aforementioned stabilization and secondly the facilitation of installation.

During the later actuating operation, the stop edges of the actuator abut, in the actuated state, against counterpart stop edges of the busbar. At the same time, the protuberance of the clamping limb of the clamping spring makes mechanical contact with the actuation web of the actuator. Thus, in the moment in which static friction acts, that vector component of the spring force which acts counter to the actuation direction increases, and that vector component which pushes the actuation web of the actuator against the busbar perpendicularly with respect to the actuation direction decreases, resulting firstly in an advantageous decrease in friction, in particular in the aforementioned static friction, and secondly in an advantageous increase of the restoring force.

### BRIEF DESCRIPTION OF THE DRAWINGS

An exemplary embodiment of the invention is illustrated in the drawings and will be discussed in more detail below. In the drawings:

FIG. 1a shows an actuator having latching depressions;

FIG. 1b shows a cage-like busbar having a plug-in contact;

FIGS. 1c, 1d show a V-shaped clamping spring;

FIG. 2 shows a stabilized actuator having stiffening ribs;

FIG. 3 shows a contact unit having a plug-in contact fastened thereto;

FIGS. 4a-d show an actuating operation obliquely from above and in section;

FIGS. 4e, f show the stabilized actuator having the contact unit in section and in a side view;

FIGS. 5a, b show, in section, the actuation of a connection device;

FIG. 5c shows a cable;

FIG. 5d shows a wire end ferrule of the cable;

FIGS. 6a, 6b show the actuation of a cable connection system;

FIG. 7a shows the contact unit having the plug-in contact and a contact carrier;

FIG. 7b shows the contact carrier having contact units inserted therein;

FIG. 8a shows the stabilized actuator and the contact carrier having installation strips;

FIG. 8b shows a plug-in connector insert having a holding plate that is to be latched onto the contact carrier.

### DETAILED DESCRIPTION

The figures contain, in part, simplified schematic illustrations. In some cases, the same reference designations will be used for similar but not necessarily identical elements. Different views of the same elements may be scaled differently.

The figures illustrate a contact carrier apparatus and an associated actuator 1, l′ in two different embodiments, a connection device, a plug-in connector insert and an associated installation method, and also a cable connection system and the actuation thereof.

The cable connection system has the actuator 1, 1′, has a cage-like busbar 2, 2′ having a cable connection side 26, has a V-shaped clamping spring 3, and has a cable 6 having a collar 613, 613′, which cable is to be inserted into the busbar 2, 2′ through the cable connection side 26 in an insertion direction and electrically connected and thus attached to the busbar 2 by means of the clamping spring 3. Also shown are a plug-in contact 5, which is electrically and mechanically connected to the busbar 2, 2′at a connecting portion 25, and a contact carrier 4, which receives the aforementioned arrangement and encloses it by being latched together with a holding plate 41.

In the drawing, the cable connection side 26 is generally illustrated at the top. In the drawing, the insertion direction of the cable generally extends from top to bottom. The actuation direction of the actuator extends parallel to the insertion direction, and therefore likewise generally from top to bottom in the drawing.

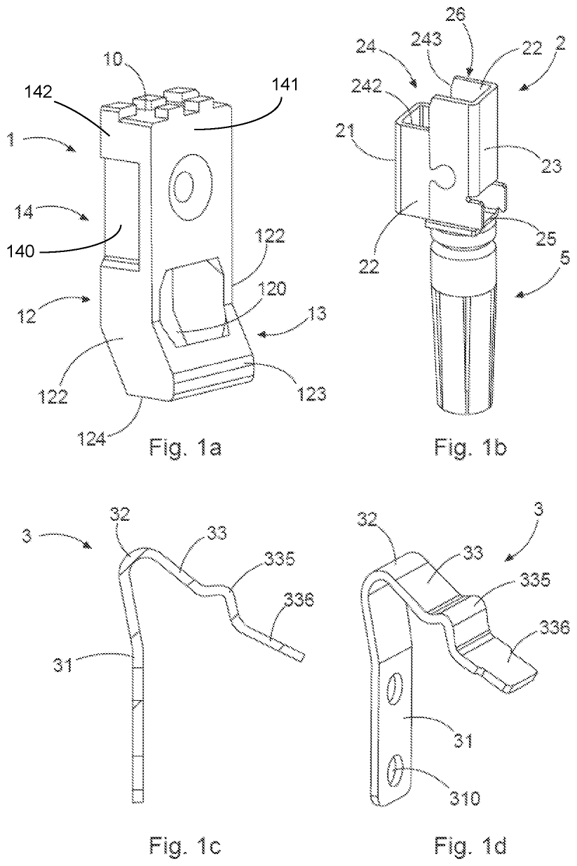

FIG. 1a shows the actuator 1 in a first, less preferred embodiment. Said actuator 1 has a substantially cuboidal holding portion 14 by which it can be held in the contact carrier 4. The holding portion thus has two wide-side surfaces 141 and two narrow-side surfaces 142, of which in each case only one is visible in the drawing because the other is concealed by the actuator 1. At the end at the cable connection side (illustrated at the top in the drawing), the actuator 1 has an engagement surface 10, for example for the engagement of a tool, for example of a flat-tip screwdriver. The engagement surface 10 has a structure that facilitates the engagement of the flat-tip screwdriver.

Adjoining the holding portion 14 at the plug-in side, said actuator 1 has an actuation portion 12 for interacting with the cage-like busbar 2, which is presented below, and with the clamping spring 3, which is to be described in more detail below. The actuation portion 12 has two planar, mutually opposite actuation arms 122, which are connected to one another at the ends via an actuation web 123. On the actuator 1, the actuation web 123 forms at least a part of a projection 13.

A passage opening extending perpendicularly with respect to the actuation direction (that is to say horizontally in the drawing), namely a receiving opening 120, remains between the actuation arms 122. In the vicinity of the actuation web 123 (at the bottom in the drawing), a part of this receiving opening 120 extends into the projection 13. Adjoining the actuation web 123, the actuation arms 122 each have a stop edge 124 that terminates flush with the actuation web 123 in the actuation direction.

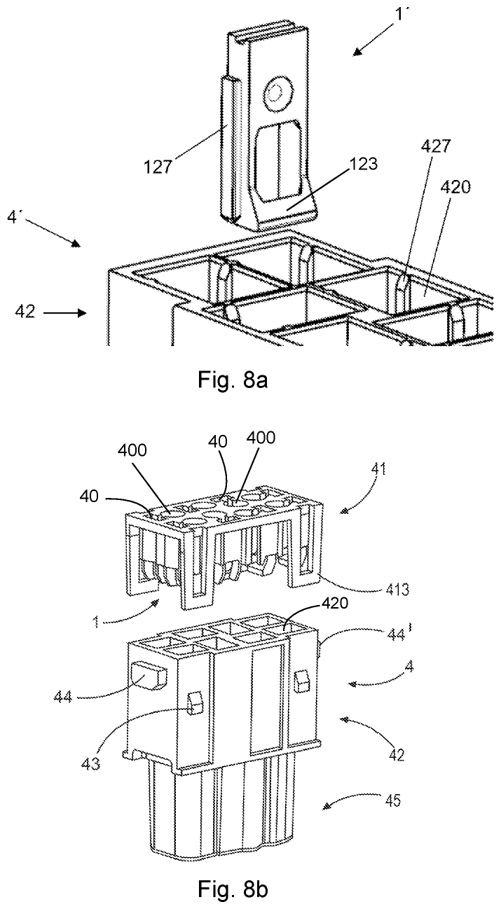

In the embodiment shown here, the actuator 1 furthermore has, at the narrow side, latching depressions 140 which are formed into the holding portion 14. In other words, the latching depressions 140 are arranged in the narrow-side surfaces 142. Said latching depressions are used for preinstallation on a holding plate 41 in order to facilitate the later installation process (as illustrated for example in FIG. 8b).

It is however easily conceivable that this latching depression is detrimental to the stability of such an actuator 1 of a conventional size, which has a height for example in the region of approximately 1 cm. Depending on other circumstances, such an actuator 1 in the embodiment shown here can easily break during operation, in particular under adverse circumstances, for example if said actuator is formed from plastics material.

FIG. 1b shows a cage-like busbar 2 having a plug-in contact 5 fastened and electrically conductively connected thereto. In the embodiment shown here, the busbar 2 is a punched and bent part. During its production, said busbar may thus for example be punched out of a metal sheet and bent into the desired shape. In other embodiments, the cage-like busbar 2 could also be produced by zinc die casting or by milling “from a solid piece”, that is to say from a solid piece of material, or the like.

In the embodiment shown here, the busbar 2 has a cage comprising two mutually parallel and opposite cage walls 21, 23, namely a first cage wall 21 and a second cage wall 23, which are connected to one another by two further walls of the cage, namely two side walls 22.

The two side walls 22 each have, at a cable connection side, a stepped portion 24 that forms in each case one sliding edge 243 extending in the insertion direction and one counterpart stop edge 242 extending preferably at right angles to said sliding edge. For connection to the plug-in contact 5, the busbar 2 has, at a plug-in side, the connecting portion 25 for electrical and mechanical connection to the plug-in contact 5.

FIGS. 1c and 1d show a clamping spring 3 in a side view and obliquely from above. The clamping spring 3 is substantially V-shaped. It has a holding limb 31 and a clamping limb 33, which are connected to one another via a spring bend 32. As can be seen from FIG. 1d, holding means, more specifically holding openings, are arranged in the holding limb 31. These serve for holding the clamping spring on, or even fastening the clamping spring to, the first cage wall 21.

At the spring bend 32, the spring is bent through more than 270°, such that the two limbs 31, 33 form an acute angle with respect to one another. The clamping limb 33 has a protuberance 335 and, adjoining this, a contact region 336.

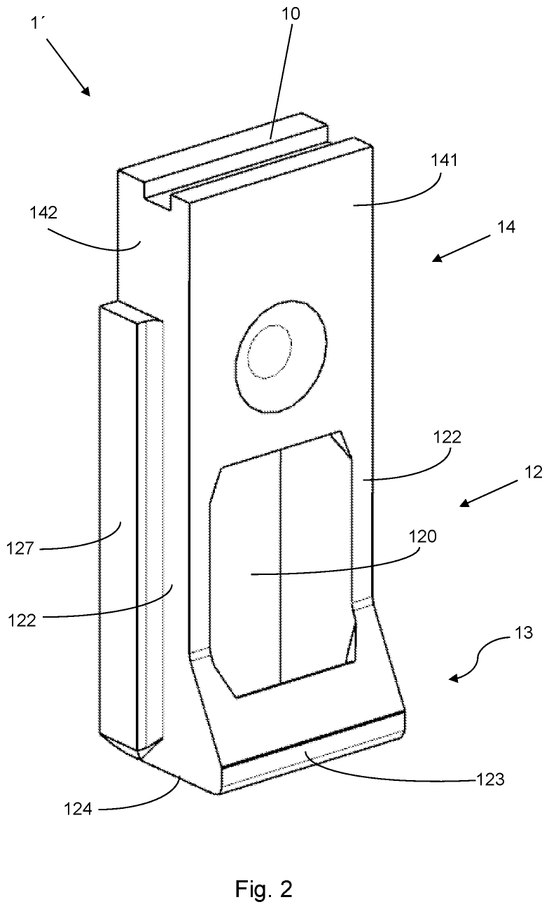

FIG. 2 shows the actuator 1′ in a second embodiment. This actuator 1′ corresponds in many aspects to the aforementioned embodiment 1, but has no latching depression 140 and, even if formed from plastics material, in particular from glass-fiber-reinforced polyamide, exhibits much greater stability than the aforementioned embodiment, for the following reason:

Specifically, to increase stability, in each case one stiffening rib 127 is formed at the outside on the two fastening arms 122 of the actuator 1′, said stiffening rib extending over approximately the entire actuation portion 12 and into the holding portion 14, more specifically into a narrow-side surface 142 of the holding portion 14. The actuator 1′ thus has a total of two stiffening ribs 127, of which only one is visible in the drawing because the other is concealed by the actuator 1′. The two stiffening ribs 127 of the actuator 1′ are directed outwardly, that is to say away from one another, and extend in the actuation direction (that is to say vertically in the drawing), wherein the actuation direction of the actuator 1, 1′ also corresponds, in all of the examples shown, to the insertion direction of the electrical conductor 60, 630.

As is readily apparent from the drawing, the length, measured in the actuation direction, of the stiffening ribs 127 is more than ⅔ (“two thirds”) of the length, measured in the actuation direction, of the actuator 1′. Here, the stiffening ribs 127 extend over approximately the entire actuation portion 12 of the actuator 1′ and into the holding portion 14 of the actuator 1′. The thickness of the stiffening rib 127 at least corresponds to, or is even somewhat greater than, the thickness of the actuation arms 122. The stiffening rib 127 is furthermore at least half as wide as the narrow-side surface 142 of the holding portion 14 of the actuator.

It is thus clearly apparent that, owing to the stiffening ribs 127, this actuator 1′ is of much more stable design than the actuator 1 shown in the preceding embodiment.

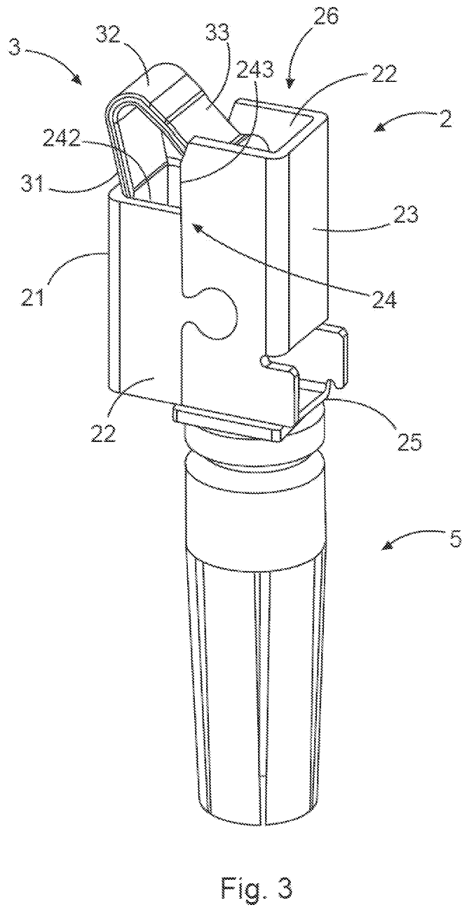

FIG. 3 shows a contact unit comprising the busbar 2 and the clamping spring 3 together with a plug-in contact 5 that is riveted to the busbar 2.

The busbar 2 has the encircling cage, which has the two mutually opposite cage walls 21, 23 and the two side walls 22. The cage is formed by a sheet-metal punched and bent part which has multiple right-angled bends and is closed at its ends. At a connection side (illustrated at the top in the drawing), the cage is open at least for the insertion of the electrical conductor 60, 630. At a plug-in side (illustrated at the bottom in the drawing), the cage has the connecting portion 25, to which the plug-in contact 5 is fastened and via which said cage is electrically conductively connected to the busbar 2.

The separate, substantially V-shaped clamping spring 1, which consists of resiliently elastic sheet steel, is arranged partially in the interior of said cage. The clamping spring 3 has a spring bend 32, which projects out of the cage at a cable connection side.

The clamping spring 3 furthermore has a holding limb 31 and a clamping limb 33, which are connected to one another via the curved spring bend 32. The holding limb 31 is fastened to or at least held on a first cage wall 21 within the cage, that is to say from the inside. For example, by way of the holding openings 310 of its holding limb 31, the clamping spring 3 may be held against the first cage wall 21 from the inside, for example by way of inwardly directed embossed portions in the first cage wall 21 which prevent at least a displacement of the clamping spring 3 in or counter to the insertion direction in an effective manner and with only little installation effort.

The embodiment shown here makes it possible for the clamping spring 3 to be supported against the first cage wall 21 from the inside whilst pressing with its clamping limb 33, specifically with its contact region 336, against the second cage wall 23. When an electrical conductor 60, 630 is plugged in the insertion direction into the busbar 2 between the second cage wall 23 and the second clamping limb 33 of the clamping spring 3, said electrical conductor 60, 630 is pushed by the clamping spring 3, by way of the clamping limb 33, specifically by way of the contact region 336 thereof, against the second cage wall 23 and is thus electrically conductively connected thereto and mechanically held, specifically clamped, thereon, and can thus no longer readily be pulled out counter to the insertion direction. The electrical conductor 60, 630 may for example be a wire 60 of an electrical cable 6, in particular together with a crimped region 630 of a wire end ferrule 63 crimped thereon, as will be presented in more detail below.

The electrical conductor, for example the wire 60 of an electrical cable 6, in particular together with a crimped region of 630 of a crimped sleeve 63 crimped on the cable 6, can then be inserted into the cage from the direction of a cable connection side (that is to say from above in the drawing) and clamped between the clamping limb 33, which thus pivots in the direction of a plug-in side, and the second cage wall 23 in order to be connected to the contact unit, that is to say electrically conductively connected thereto and mechanically fixed thereon, at least in a movement direction toward the cable connection side. The electrical conductor 60, 360 is then secured against being pulled out, specifically is clamped between the clamping limb 33 and the second cage wall 23, and is at the same time electrically connected to the busbar 2.

At a plug-in side, the busbar 2 has the aforementioned connecting portion 25. Said connecting portion 25 consists in a sheet-metal portion that is angled at right angles with respect to the plug-in direction, and said connecting portion has a through bore to which the plug-in contact 5 is fastened, for example by riveting, and is thus also electrically conductively connected. The plug-in contact 5 shown here is a socket contact. In another embodiment, it may self-evidently also be a pin contact.

The plug-in contact 5 and the busbar 2 may be manufactured from different electrically conductive materials, in particular different metals, using different methods.

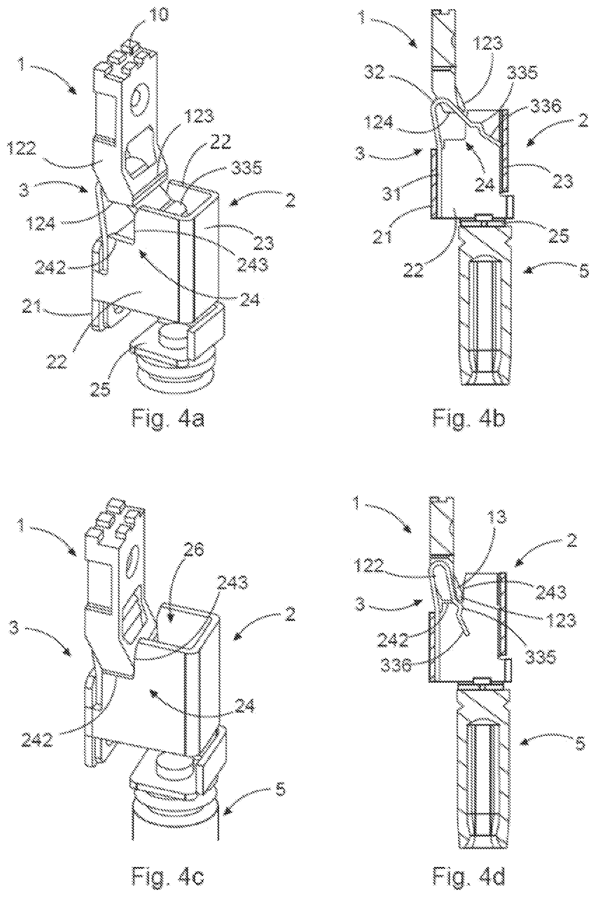

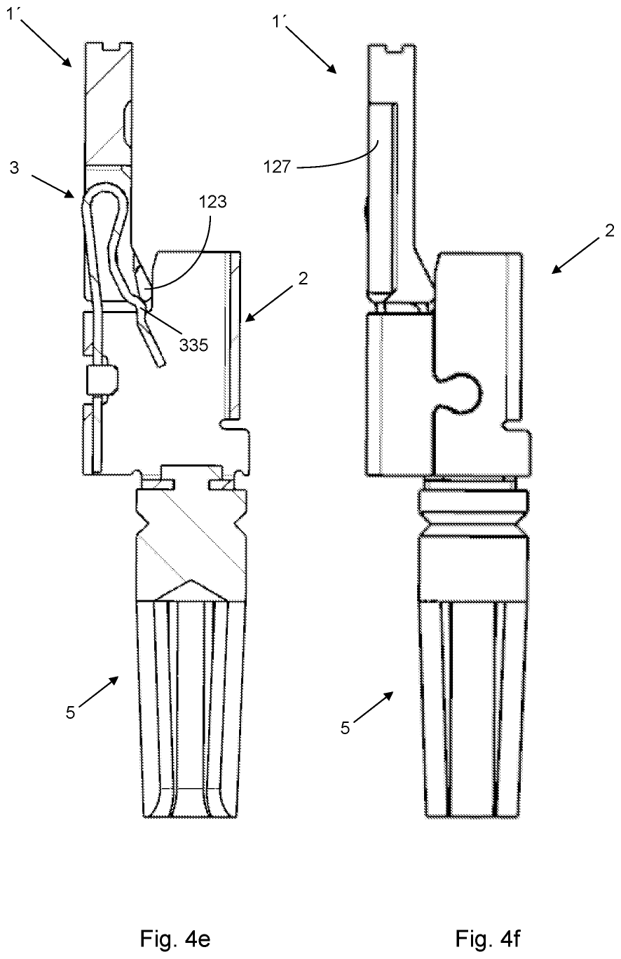

FIGS. 4a and 4b show, in a 3D illustration and a sectional illustration respectively, the busbar 2 with the clamping spring 3 and the actuator 1 in a non-actuated state. FIGS. 4c and 4d show the arrangement in question in an actuated state.

The side walls 22 of the busbar 2 each have the aforementioned stepped portion 24 having the sliding edge 243 and the counterpart stop edge 242.

It is readily apparent from these illustrations that, when actuated and thus displaced in the insertion direction, that is to say from top to bottom in the drawing, the actuator 1 slides with its actuation web 123 along the sliding edges 243 of the busbar 2 until said actuator abuts by way of its stop edges 124 against the counterpart stop edges 242 of the busbar 2, as shown in FIGS. 4c and 4d. It is also apparent in particular from FIG. 1d that, at this moment in which the actuator is stationary and in which the sliding friction between the actuator 1 and the busbar 2 has changed from sliding friction to static friction, the actuation web 123 of the actuator 1 is in mechanical contact with the protuberance 335 of the clamping limb 33 of the clamping spring 3. Here, as a result of the aforementioned actuation, the clamping limb 33 has pivoted in the insertion direction in relation to its position illustrated in FIG. 4b.

The mechanical contact of the actuation web 123 with the protuberance 335 causes the actuator 1 to be pushed with greater intensity in the direction of the cable connection side 26 (that is to say upward in the drawing), and with correspondingly lesser intensity perpendicularly with respect thereto against the sliding edge 243, by the clamping spring 3. It is particularly advantageous that this vectorial change in direction of the acting force occurs exactly at the time at which particularly high static friction, which must be overcome, occurs. In the actuated position, that vectorial component which causes said friction, in particular the aforementioned static friction, decreases owing to the protuberance 335. In return, that vectorial component which acts counter to the insertion direction, and exerts a restoring force on the actuator, increases. It is thus possible both for the static friction to be additionally somewhat further reduced, and for the force component in the movement direction of the actuator 1, which overcomes said static friction, to be increased.

Since this aforementioned effect is however also limited by said protuberance 335, it is furthermore particularly advantageous for the static friction that occurs between the actuator 1 and the busbar 2, specifically between the actuation web 123 and the sliding edges 243, to also be minimized by way of other/additional measures. This static friction may furthermore be reduced by minimizing the contact area between the actuation web 123 of the actuator 1 and the sliding edges 243 of the busbar 2. Firstly, therefore, it is highly advantageous simply that the actuation web 123 extends perpendicularly with respect to the sliding edges 243. It is furthermore also advantageous for the actuation web 123 to have a rounded form facing the sliding edges 243.

FIGS. 4e and 4f show a similar arrangement in section and in a side view, with the actuator 1′ being of the stabilized design, that is to say having the stiffening ribs 127.

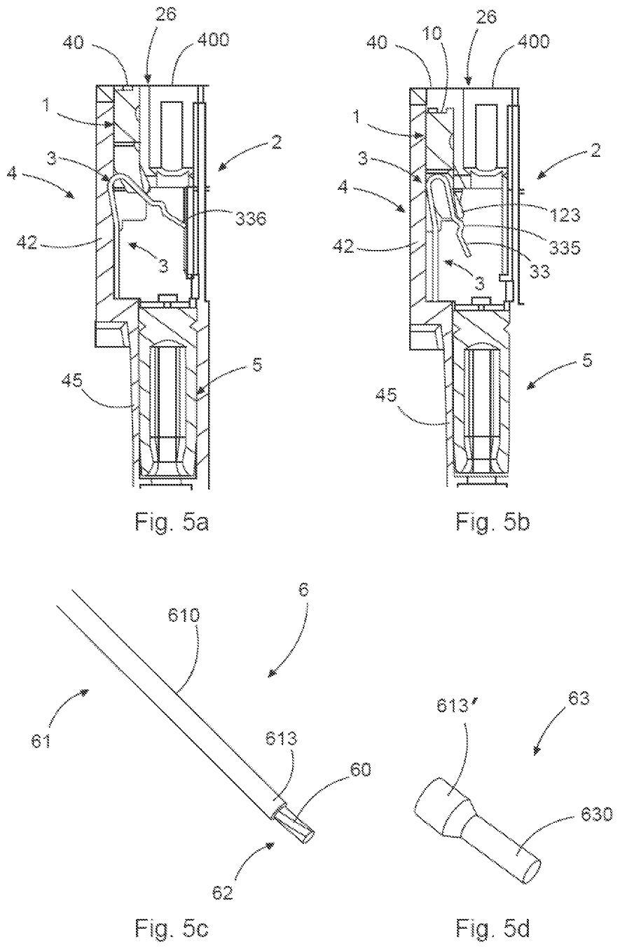

FIGS. 5a and 5b show a similar arrangement and a similar operation, and additionally illustrate that the actuator 1 and the busbar 2 and thus also the clamping spring 3 and the plug-in contact 5 are received and held in a contact carrier 4. Although the actuator 1 is explicitly referred to here, this cross-sectional illustration applies similarly to the stabilized actuator 1′.

For this purpose, the contact carrier 4 has a connection region 42 for receiving the busbar 2, the clamping spring 3 and the actuator 1, and has a plug-in region 45, which is open at a plug-in side (at the bottom in the drawing), for receiving the plug-in contact 5 and for plugging together with a mating connector, for example.

Here, the actuator 1 is in a recessed arrangement in an actuation opening 40 of the holding plate 41 and of the contact chamber 420 of the contact carrier 4, and is actuatable through said actuation opening 40 from a cable connection side, for example using a flat-tip screwdriver or some other tool. During the actuating operation, the actuator 1 may be guided by means of the contact carrier 4, for example by the holding plate. The main friction resistance however arises between the actuator 1 and the busbar 2, against which the actuator 1 is pushed by the clamping spring 3. Although the actuator 1 is explicitly referred to here, this cross-sectional illustration applies similarly to the stabilized actuator 1′.

The holding plate 41 of the contact carrier 4 furthermore has a connection opening 400 through which a cable 6 can be inserted into the busbar 2 in the insertion direction, that is to say from top to bottom in the drawing, in order to be contacted with the busbar 2.

FIG. 5c shows an electrical cable 6, and FIG. 5d shows an associated wire end ferrule 63. The cable 6 has an electrically conductive wire 60, has a transmission portion 61 and, at its end that is to be inserted into the busbar 2, has a contact portion 62. In its transmission portion 61, the electrical cable 6 has an electrically insulating sheath 610 that radially surrounds the wire 60. The contact portion 62 of the cable 6 serves for making electrical contact with the busbar 2 and therefore has no electrically insulating sheath 610, such that the wire 60 of the cable 6 is not sheathed in the contact portion 62. Adjacent to the contact portion 62, the cable 6 has a collar 613, 613′ on its transmission portion 61. The collar 613, 613′ consists of an electrically insulating material. In one embodiment, the collar 613 is formed by an end portion of the sheath 610. Alternatively, in another embodiment, the may have, at the end, the wire end ferrule 63 which is fitted, and crimped by way of its crimped region 630, onto the cable end that is to be inserted. Said collar 613′ may then belong to the wire end ferrule 63. In particular, the collar 613′ is then a so-called “protective collar” of the wire end ferrule 63.

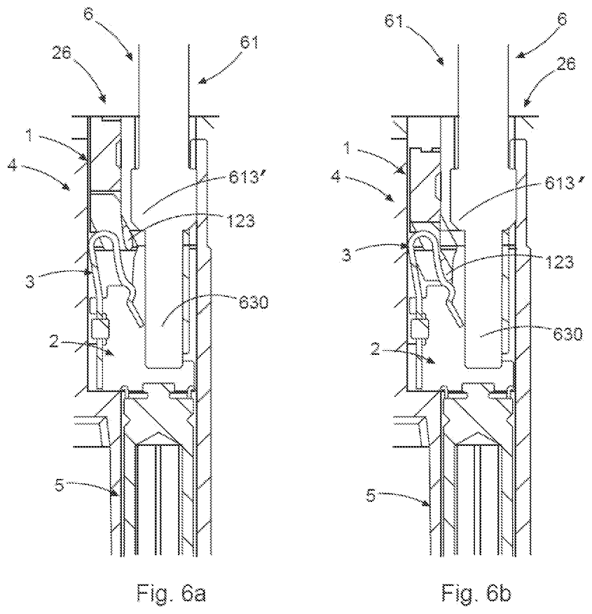

FIG. 6a shows a cable connection system comprising the actuator 1, the cage-like busbar 2, the V-shaped clamping spring 3 and the cable 6, with the actuator 1 being situated in its non-actuated position. FIG. 6b shows the same arrangement in the actuated state. Although the actuator 1 is explicitly referred to here, this cross-sectional illustration applies similarly to the stabilized actuator 1′.

It is clear from both of these illustrations how the cable 6 is arranged with the collar 613′, and with its stripped and crimped contact portion 62, which is thus surrounded by the crimped region 630 of the wire end ferrule 63, in the busbar 2.

Both in the actuated state and in the non-actuated state, the collar 613′ of the cable 6 is arranged in each case at a cable connection side of the actuation web 123 of the actuator 1, that is to say above said actuation web in the drawing.

Owing to this deep arrangement of the actuation web and owing to the receiving opening 120, it is possible for cables 6 with large cross sections, which naturally also have a large collar 316, 316′, to be received by a very compact cable connection system. Furthermore, additional space for receiving particularly large regions of the clamping spring 3 are created by the receiving opening of the actuator. In other words, the compactness of the design of the cable connection system in relation to the possible size of the cable cross section of the cable 6 that is to be received is further improved.

The minimization of the friction resistance and in particular of the static friction resistance of the actuator 1 on the busbar 2, as described in detail above, is likewise made possible by virtue of the actuation web 123 being at least a constituent part of the projection 13.

It is furthermore readily apparent from this illustration that the actuator should be formed from an electrically insulating material, because the metallic clamping spring 3 is in electrical contact with the electrical conductor 60, 630.

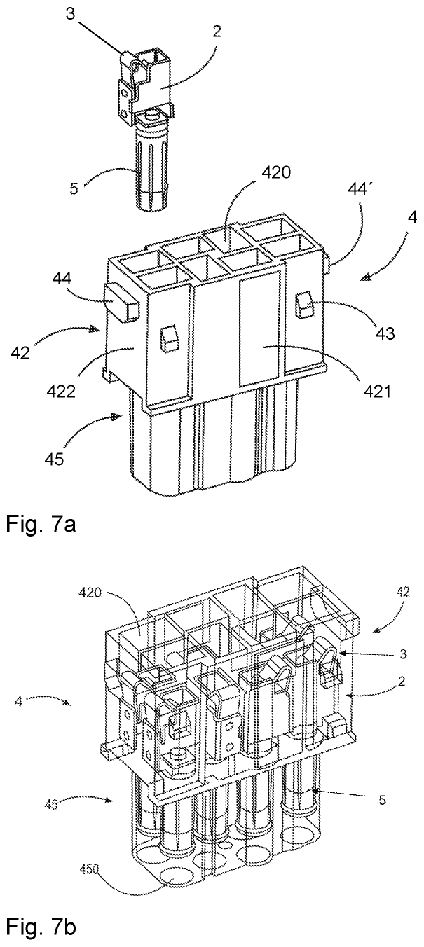

FIGS. 7a and 7b show the contact unit, comprising busbar 2 and clamping spring 3 together with the plug-in contact 5 attached to the busbar 2; these are inserted jointly into a contact chamber 420 of a contact carrier 4.

FIG. 7a shows the contact unit that is to be inserted, as a representative of eight contact units 3, and shows the contact carrier 4 with its eight contact chambers before the insertion operation, that is to say before the contact carrier 4 is populated with the contact units 3.

The contact carrier 4 is formed as a single piece, has a connection region 42 at a cable connection side, said connection region having the aforementioned contact chambers 420, and also has a plug-in region 45 at a plug-in side.

The connection region 42 is substantially cuboidal and has two narrow-side walls 422 and two wide-side walls 421. Latching hooks 43 for the fastening of the holding plate 2 are formed on the two wide-side walls 421 of said connection region. In each case one latching lug 44, 44′ for fastening in a modular plug-in connector frame are formed on the two narrow-side walls. The two latching lugs 44, 44′ differ from one another in terms of their width in order to ensure the correct polarization of a plug-in connector insert, designed as a plug-in connector module, in a modular plug-in connector frame.

FIG. 7b shows the contact carrier 4 in a transparent illustration with multiple contact units, which have been inserted into in each case one contact chamber 40 of the contact carrier 4. Situated in the connection region 42 are the contact chambers 420, in which the busbar 2 of the contact unit is arranged. The plug-in region 45 has plug-in openings 450 extending in a plug-in direction, which plug-in openings are connected to the particular contact chamber 420 and serve to receive the plug-in contact 5 of the contact unit.

FIG. 8a shows the stabilized actuator 1′ as a representative of eight such actuators 1′ that are to be inserted into the contact carrier 4′. As already mentioned, said actuator 1′ has the stiffening ribs 127. The contact carrier 4′ shown here is likewise correspondingly modified in relation to the contact carrier 4 presented above and below and has, in each contact chamber 420, two mutually oppositely arranged installation strips 427. More specifically, for the purposes of facilitating installation, the contact carrier 4′ has, within its contact chamber 420 on two mutually opposite inner surfaces of the contact chamber 420, in each case one inwardly directed installation strip 427 extending in an insertion direction. Furthermore, as already shown in the preceding illustration, a contact unit (not visible in this illustration) is already present in each contact chamber 420 of the contact carrier 4.

It is readily apparent from this illustration that, for the purposes of preinstallation, the actuator 1′ is inserted into the contact chamber 420 at a connection side (that is to say from above in the drawing), wherein the stiffening ribs 127 of said actuator engage behind the installation strips 427 of the contact chamber 420. The actuator 1′, in its preinstalled position, therefore cannot tilt to too great a degree, and is thus situated in a correct relative position with respect to the holding plate 41 during the final installation operation. Here, the actuator 1′ rests with its actuation web 123, as shown in FIG. 5a, on the clamping limb 33 of the clamping spring 3. The actuator 1′ is thus held in the contact chamber 420 in a preinstallation position by the contact carrier 4′. When the holding plate 41 is latched onto the contact carrier 4′, the actuator 1′ is guided in its desired actuation movement inter alia by contours of the holding plate 41, and is furthermore held in the contact carrier 4 so as to be actuatable.

FIG. 8b shows a plug-in connector insert with the holding plate 41, comprising eight actuation openings 40, eight insertion openings 400 which are adjacent and connected to said actuation openings, and eight actuators 1 of the less preferred design variant, which are thus already held, in the preinstallation state, at the respective actuation openings 40 of the holding plate 41. In this case, as an alternative to the previously mentioned arrangement, the actuators 1 have specifically been preinstalled by way of their latching depressions 140, shown in FIG. 1, on the holding plate 41, in order to be inserted into the contact chambers 420 at the same time as the holding plate 41 is installed. The arrangement otherwise substantially corresponds to that which corresponds to the aforementioned construction from FIG. 8a. The installation method described below also corresponds to the installation method of the aforementioned arrangement: The holding plate 41 has four latching lugs 413, each having a latching window for latching onto the latching hooks 43 of the contact carrier 4. Owing to this fixing of the holding plate 41 to the contact carrier 4 by latching, it is also the case in this design that the actuators 1 are guided in their desired actuation movement inter alia by means of the holding plate 41, and are furthermore held in the contact carrier 4 so as to be actuatable.

The disadvantage of this latter design in relation to that shown in FIG. 8a consists in particular in the lower stability of the corresponding actuators 1 under otherwise identical conditions, or, conversely, in the need to produce said actuators 1 at correspondingly higher cost from a more stable material.

Conversely, the stabilized actuator 1′ in the particularly preferred embodiment as shown in the preceding FIGS. 8a and 4f and also particularly clearly in FIG. 2 has the advantage of having particularly high stability whilst being virtually equivalently capable of being preinstalled. A major advantage of the arrangement shown in FIG. 8a therefore consists in the ability to produce the actuator 1′ inexpensively from plastics material by injection molding. Said actuator 1′ with its stiffening rib 127 can ultimately consist of plastics material, in particular of glass-fiber-reinforced polyamide, and thus be mass-produced with all of its sophisticated shaping inexpensively in large unit quantities by injection molding.

Even though various aspects or features of the invention have been presented in each case in combination in the figures, it is apparent to a person skilled in the art that—unless stated otherwise—the combinations that have been illustrated and discussed are not the only possibilities. In particular, mutually corresponding units or feature combinations from different exemplary embodiments may be interchanged with one another.

### LIST OF REFERENCE DESIGNATIONS

1, 1′ Actuator
10 Engagement surface
12 Actuation portion
120 Receiving opening
122 Actuation arms
123 Actuation web
124 Stop edge
127 Stiffening rib
13 Projection
14 Holding portion
140 Latching recess
141 Wide-side surfaces
142 Narrow-side surfaces
2 Cage-like busbar
21 First cage wall
22 Side walls
23 Second cage wall
24 Stepped portion
242 Counterpart stop edge
243 Sliding edge
25 Connecting portion
26 Cable connection side
3 Clamping spring
31 Holding limb
310 Holding opening
32 Spring bend
33 Clamping limb
335 Protuberance
336 Contact region
4, 4′ Contact carrier
40 Actuation opening
400 Connection opening
41 Holding plate
413 Latching lugs
420 Contact chamber
42 Connection region
421 Wide-side walls
422 Narrow-side walls
427 Installation strip
43 Latching hook
44, 44′ Latching lugs
450 Plug-in openings
45 Plug-in region
5 Plug-in contact
6 Cable
60 Wire, electrical conductor
61 Transmission portion
610 Sheath
613, 613′ Collar, protective collar
62 Contact portion
63 Wire end ferrule
630 Crimped region, electrical conductor

1.-19. (canceled)

20. A contact carrier apparatus, comprising:
a contact carrier (4, 4′), having a connection region (42) at a cable connection side, and
at least one contact chamber (420), which is open at the cable connection side, for receiving a contact unit;
a holding plate (41) which is connectable and fixable at the cable connection side to the contact carrier (4, 4′), the holding plate (41) having an actuation opening (40) for each at least one contact chamber (420), and a connection opening (400), which is adjacent to the actuation opening (40) and/or connected to the actuation opening (40), for inserting an electrical conductor (60, 630) at the cable connection side into the at least one contact chamber (420) in an insertion direction,
wherein the contact carrier apparatus has, at each actuation opening (40), an actuator (1′) arranged at least partially in the corresponding contact chamber (420) and held therein so as to be actuatable in an actuation direction, for releasing the electrical conductor (60, 630) from the contact unit,
wherein the actuator (1′) has a holding portion (14) having an engagement surface (10),
an actuation portion (12) having two lateral actuation arms (122) extending in the actuation direction, and
an actuation web (123) which connects ends of the two lateral actuation arms (122), for actuating the contact unit,
wherein the actuator (1′) is of open design between the two lateral actuation arms (122) in a region between the actuation web (123) and the holding portion (14), and
wherein a stiffening rib (127) is formed at an outside on each of the two lateral actuation arms (122) of the actuator (1′).

21. The contact carrier apparatus as claimed in claim 20,
wherein the actuation direction and the insertion direction extend parallel to one another.

22. The contact carrier apparatus as claimed in claim 20,
wherein the stiffening ribs (127) of the actuator (1′) extend in the actuation direction.

23. The contact carrier apparatus as claimed in claim 20,
wherein a length, measured in the actuation direction, of each stiffening rib (127) corresponds to more than two thirds of a length, measured in the actuation direction, of the actuator (1′).

24. The contact carrier apparatus as claimed in claim 20,
wherein the stiffening ribs (127) extend over approximately an entire actuation portion of the actuator (1′) and further into the holding portion (14) of the actuator (1′).

25. The contact carrier apparatus as claimed in claim 20,
wherein a thickness of each of the stiffening ribs (127) at least corresponds to, or is greater than, a thickness of the actuation arm (122) on which the respective stiffening rib (127) is formed.

26. The contact carrier apparatus as claimed in claim 20,
wherein each of the two stiffening ribs (127) is at least half as wide as a narrow-side surface (142) of the holding portion (14).

27. The contact carrier apparatus as claimed in claim 26,
wherein each of the two stiffening ribs (127) and a narrow-side surface (142) of the holding portion (14) have a same width.

28. The contact carrier apparatus as claimed in claim 20,
wherein, in an installed state,
the actuator (1′) is in a recessed arrangement in a system formed from the contact carrier (4, 4′) and the holding plate (41) that is latched together with the contact carrier, or
the actuator terminates flush with the holding plate (41).

29. The contact carrier apparatus as claimed in claim 20,
wherein, for facilitating installation, the contact carrier (4′) has, within the contact chamber (420) on two mutually opposite inner surfaces of the contact chamber (420), in each case one inwardly directed installation strip (427) extending in an insertion direction.

30. A connection device, comprising:
the contact carrier apparatus as claimed in claim 20; and
a contact unit inserted therein, comprising
a busbar (2) and
a clamping spring (3),
wherein the busbar (2) is arranged together with the clamping spring (3) in the contact chamber (420) of the contact carrier apparatus,
wherein the busbar (2) has a cage which is open at the cable connection side and which has two mutually parallel and opposite cage walls (21, 23), namely a first cage wall (21) and a second cage wall (23), which are connected to one another by two side walls (22) to form the cage, and
wherein the clamping spring (3) is V-shaped and has a holding limb (31), which is fastened to or at least held against the first cage wall (21), and, adjoining its holding limb (31),
a spring bend (32), and, adjoining the spring bend (32),
an elastically pivotable clamping limb (33),
wherein the clamping limb (33) serves, in a non-actuated state of the clamping spring (3), to press the electrical conductor (60, 630) against the second cage wall (23) of the busbar (2) in order to electrically connect the electrical conductor (60, 630) to the busbar (2) and in order to secure the electrical conductor (60, 630), by clamping it against the second cage wall (23), so as to prevent the electrical conductor from being inadvertently pulled out counter to the insertion direction,
wherein the two side walls (22) each have, at the cable connection side, a stepped portion (24) that forms a sliding edge (243) extending in the insertion direction,
wherein the actuation web (123) of the actuator extends perpendicular to the sliding edges (243) of the side walls (22) of the busbars (2, 2′) and is in mechanical contact with the sliding edges (243) so as to be capable, when actuated, of sliding along the sliding edges (243) to guide the actuator (1′) and of simultaneously sliding along the clamping limb (33) of the clamping spring (3) to transfer the clamping spring (3) from the non-actuated state into an actuated state,
wherein the clamping limb (33), when in the actuated state, has been pivoted in the insertion direction relative to its non-actuated state, such that the clamping spring (3) imparts an opposing force to release the electrical conductor (60, 630) again so as to enable the electrical conductor (60, 630) to be pulled out at a cable connection side.

31. The connection device as claimed in claim 30,
wherein the stepped portion (24) in each of the two side walls (23) forms not only the sliding edge (243) but also a counterpart stop edge (242) extending at right angles to the sliding edge (243), and
wherein the actuation arms (122) of the actuator (2) have, at the ends, stop edges (124) by which the actuator (2), in the actuated state, abuts against the counterpart stop edges (242) of the side walls (22).

32. An actuator (1′) for the connection device as claimed in claim 30, comprising:
a holding portion (14) having an engagement surface (10);
an actuation portion (12) having two lateral actuation arms (122) extending in an actuation direction; and
an actuation web (123) which connects end of the actuation arms (12) and serves for actuating the contact unit,
whereby the actuator is of open design in a region between the actuation web (123) and the holding portion (14),
wherein at least one stiffening rib (127) is formed at an outside on each of the actuation arms (122) of the actuator (1′), and
wherein the actuator (1′) consists of plastic material.

33. A plug-in connector insert, comprising:
the connection device as claimed in claim 30; and
a plug-in contact (5) which is electrically connected and mechanically fastened to the busbar (2),
wherein the contact carrier (4, 4′) has, at a plug-in side of the connection region (42), a plug-in region (45) in which, for each contact chamber (40), there is arranged a plug-in opening (450) which is connected to the respective contact chamber (40) and in which the respective plug-in contact (5) is received.

34. The plug-in connector insert as claimed in claim 33,
wherein the connection region (41) of the contact carrier (4, 4′) is substantially cuboidal and has two mutually opposite narrow-side walls (422) and, at right angles with respect thereto,
two mutually opposite wide-side walls (421),
wherein the contact carrier (4, 4′) has, on the two narrow-side walls (422), in each case one latching lug (44, 44′) for fixing in a modular plug-in connector frame.

35. The plug-in connector insert as claimed in claim 34,
wherein the two latching lugs (44, 44′) differ from one another in terms of their shape to ensure correct polarization of the plug-in connector insert in the modular plug-in connector frame.

36. A method for installing a plug-in connector insert as claimed in claim 33, comprising:
inserting at least one contact unit from the direction of a cable connection side into at least one contact chamber (420) of the contact carrier (4′),
inserting at least one actuator (1′) from the direction of a cable connection side into the at least one contact chamber (420) of the contact carrier (4′), and holding the actuator (1′) in a preinstallation position by the contact carrier (4′);
joining the holding plate (41) to the contact carrier (4′), and
establishing definitive guidance of the at least one actuator (1′) on one or more contours of the holding plate (41) by latching the holding plate (41) together with the contact carrier (4′).

37. A cable connection system, comprising:
the plug-in connector insert as claimed in claim 33; and
an electrical cable (6),
wherein the actuation web (123) of the actuator (1′) is arranged at a plug-in side of a collar (613, 613′) of the electrical cable (6).

38. The cable connection system as claimed in claim 37,
wherein the electrical cable (6) has an electrically conductive wire (60) which is surrounded by a sheath (610) in a transmission portion (61) of the cable (6) but which is not surrounded by the sheath (610) in a contact portion (62),
wherein the collar (613, 613′) is either
formed by an end portion of the sheath (610), wherein the electrical conductor (60) is formed by the wire (60) of the cable (6), or
formed by a protective collar (613′) of a wire end ferrule (63) with which the electrical cable (6) is crimped at its contact portion (62), whereby the electrical conductor (60, 630) is formed both by the wire (60) of the cable (6) and by a crimped region (630) of the wire end ferrule (63).
